(19) United States
(12) Patent Application Publication
(10) Pub. No.: US 2006/0262063 A1
(43) Pub. Date: Nov. 23, 2006

(54) Display device

(75) Inventor: Hiroyuki Takahashi, Funabashi (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/396,639

(22) Filed: Apr. 4, 2006

(30) Foreign Application Priority Data
May 18, 2005 (JP) 2005-145351

(51) Int. Cl. G09G 3/36

(52) U.S. Cl. 345/94

(57) ABSTRACT

The present invention shortens time until an operation becomes stable when a frame inversion driving method is adopted as a common inversion driving method. In a display device which includes a plurality of pixels each of which includes a pixel electrode and a counter electrode which faces the pixel electrode in an opposed manner, and a drive circuit which drives the plurality of pixels, the drive circuit includes a common voltage generating circuit which supplies a common voltage to the counter electrodes, and the common voltage generating circuit changes over a voltage level of the common voltage with a first cycle in a non-display period, and changes over the voltage level of the common voltage with a second cycle which is longer than the first cycle in a display period.

The present application claims priority from Japanese application JP2005-145351 filed on May 18, 2005, the content of which is hereby incorporated by reference into this application.

### BACKGROUND OF THE INVENTION

1. Field of the Invention

The present invention relates to a display device, and more particularly to a technique which is effectively applicable to a common voltage generating circuit of a liquid crystal display device.

2. Description of the Related Art

A liquid crystal display module adopting a TFT (Thin Film Transistor) method which includes a miniaturized liquid crystal panel has been popularly used as a display part of a portable equipment such as a mobile phone.

In general, a lifetime of liquid crystal is degenerated when a DC voltage is applied to the liquid crystal and hence, it is necessary to drive the liquid crystal using an AC current. As one of AC driving methods, there has been known a common inversion driving method.

In this common inversion driving method, the electric field direction in the inside of a liquid crystal layer is alternately changed over in the direction from a pixel electrode to a counter electrode (also referred to as a common electrode) (hereinafter referred to as writing of positive polarity) or in the direction from the counter electrode to the pixel electrode (hereinafter referred to as writing of negative polarity) for every 1 screen (frame) (hereinafter referred to as a frame inversion driving method) or for every 1 horizontal scanning period (hereinafter referred to as a I-line inversion driving method).

For example, when the black is written in a whole screen, at the time of performing the writing of positive polarity, a potential of a video voltage applied to the pixel electrode is set to 5V and a potential of a common voltage (Vcom) which is applied to the counter electrode is set to 1V, while at the time of performing the writing of negative polarity, the potential of the video voltage applied to the pixel electrode is set to 1V and the potential of the common voltage (Vcom) which is applied to the counter electrode is set to 5V.

A basic circuit which constitutes one example of a conventional common voltage generating circuit used in the common inversion driving method is shown in FIG. 6A and FIG. 7A.

Each one of the basic circuits shown in FIG. 6A and FIG. 7A includes a coupling capacitor (a capacitive element) (C) and a resistance element (R), wherein a first voltage (Vcom Swing) is applied to one terminal of the coupling capacitor (C), and a second voltage (Vcom Center) is applied to another terminal of the resistance element (R). The second voltage (Vcom Center) is a center voltage of the common voltage (Vcom).

Then, from a node between another terminal of the coupling capacitor (C) and one terminal of the resistance element (R), the common voltage (Vcom) having amplitude (VcomW) and the center voltage (Vcom Center) which is applied to the counter electrode is outputted.

Here, as a prior-art document relevant to the present invention, a following document can be named.

[Patent Document 1]

Japanese Patent Laid-open 2004-258274

### SUMMARY OF THE INVENTION

FIG. 6B indicates a waveform of the first voltage (Vcom Swing) in the 1-line inversion driving method, FIG. 6C indicates a waveform of the second voltage (Vcom Center) in the 1-line inversion driving method, and FIG. 6D indicates a waveform of the common voltage (Vcom) in the 1-line inversion driving method.

Further, FIG. 7B indicates a waveform of the first voltage (Vcom Swing) in the 1-frame inversion driving method, FIG. 7C indicates a waveform of the second voltage (Vcom Center) in the 1-frame inversion driving method, and FIG. 7D indicates a waveform of the common voltage (Vcom) in the 1-frame inversion driving method. Here, in FIG. 6B to FIG. 6D and FIG. 7B to FIG. 7D, V indicates a voltage and T indicates time.

Here, assuming a capacitive value of the coupling capacitor (C) as Ca and a resistance value of the resistance element (R) as Ra, in the circuits shown in FIG. 6A and FIG. 7A, an average voltage of the common voltage (Vcom) is converged to the second voltage (Vcom Center) with a time constant (Ra×Ca).

Further, as shown in enlarged views of FIG. 6D (portions surrounded by a circle in FIG. 6D), a High level and a Low level of the common voltage (Vcom) are attenuated toward the second voltage (Vcom Center) with an inclination (VcomW/(2×Ra×Ca)).

In the 1-line inversion driving method, since the inversion cycle is fast and hence, the average voltage is readily converged to the second voltage (Vcom Center) as indicated by A shown in FIG. 6D and hence, there arises no drawback.

However, in the 1-frame inversion driving method shown in FIG. 7A to FIG. 7D, the inversion cycle is slow and hence, the attenuation (indicated by B shown in FIG. 7D) of the common voltage (Vcom) becomes large and hence, there arises a possibility that flickers are generated on a liquid crystal display panel.

To reduce the attenuation, it is necessary to increase the time constant (Ra×Ca). However, when the time constant (Ra×Ca) is increased, the convergence of the average voltage to the second voltage (Vcom Center) is delayed.

For example, assuming the stability of the common voltage (Vcom) to 0.1% of the amplitude (VcomW), it is necessary to satisfy a following formula (1). If fFLM (frame refresh rate) is 60 Hz (fFLM=60 Hz), the time constant becomes Ra×Ca>8.33 seconds and hence, the start of the display is not smooth.
VcomW/(2×Ra×Ca×fFLM)<VcomW×0.1% (1)

To overcome the above-mentioned drawback, the above-mentioned patent document 1 discloses a technique in which, in performing the frame inversion driving method, a first resistance is used as the resistance element (R) within a predetermined period and, thereafter, a second resistance which is higher than the first resistance is used as the resistance element (R) after a lapse of a predetermined period.

According to the method disclosed in this patent document 1, the situation is improved compared to the above-mentioned case shown in FIG. 7. However, this method still possesses the drawback that the convergence to the second voltage (Vcom Center) is slow.

The present invention has been made to overcome the above-mentioned drawbacks of the related art and it is an advantage of the present invention to provide a technique which can, when a frame inversion driving method is adopted as a common inversion driving method in a display device, shorten time until an operation is stabilized.

The above-mentioned advantage and other advantages of the present invention and the novel features of the present invention will become apparent by the description of this specification and attached drawings.

To explain the summery of typical inventions disclosed in this specification, they are as follows.

(1) In a display device which includes a plurality of pixels each of which includes a pixel electrode and a counter electrode which faces the pixel electrode in an opposed manner, and a drive circuit which drives the plurality of pixels,

the drive circuit includes a common voltage generating circuit which supplies a common voltage to the counter electrodes, and

the common voltage generating circuit changes over a voltage level of the common voltage with a first cycle in a non-display period, and changes over the voltage level of the common voltage with a second cycle which is longer than the first cycle in a display period.

(2) In the constitution (1), the common voltage generating circuit attenuates the voltage level of the common voltage with a first inclination during the non-display period and attenuates the voltage level of the common voltage with a second inclination which is smaller than the first inclination during the display period.

(3) In the constitution (1) or (2), the first cycle is a 1 horizontal scanning period cycle.

(4) In any one of the constitutions (1) to (3), the common voltage generating circuit does not perform the changeover of the voltage level of the common voltage during the display period in a 1 frame period.

(5) In any one of the constitutions (1) to (4), the display device is a liquid crystal display device.

(6) In a display device which includes a plurality of pixels each of which includes a pixel electrode and a counter electrode which faces the pixel electrode in an opposed manner, and a drive circuit which drives the plurality of pixels,

the drive circuit includes a common voltage generating circuit which supplies a common voltage to the counter electrodes,

the common voltage generating circuit includes a capacitive element having one terminal to which a first voltage is applied and another terminal which constitutes an output of the common voltage, and

a resistance element having one terminal which is connected to the another terminal of the capacitive element and another terminal to which a second voltage is applied,

the first voltage is a voltage whose voltage level is alternately changed from a first voltage level to a second voltage level having a potential lower than a potential of the first voltage level or from the second voltage level to the first voltage level,

a 1 frame period includes a first period and a second period which continuously follows the first period and is longer than the first period,

in the first period, a sum of the number of change of the first voltage from the first voltage level to the second voltage level and the number of change of the first voltage from the second voltage level to the first voltage level is twice or more, and

in the second period, the first voltage has the voltage level thereof held at either one of the first voltage level and the second voltage level.

(7) In the constitution (6), a resistance value of the resistance element in the second period in the 1 frame period is higher than a resistance value of the resistance element in the first period in the 1 frame period.

(8) In the constitution (6), the display device includes a switching element which is connected to the another terminal of the resistance element,

the resistance element is configured such that the second voltage is applied to the another terminal of the resistance element via the switching element, and

the switching element is turned on in the first period of the 1 frame period, and is turned off in the second period of the 1 frame period.

(9) In any one of the constitutions (6) to (8), the first period of the 1 frame period is a vertical blanking period.

(10) In any one of the constitutions (6) to (9), the first period of the 1 frame period is a non-display period, and the second period of the 1 frame period is a display period.

(11) In any one of the constitutions (6) to (10), in the first period of the 1 frame period, the first voltage has, in a 1 horizontal scanning period cycle, the voltage level thereof changed from the first voltage level to the second voltage level or from the second voltage level to the first voltage level.

(12) In any one of the constitutions (6) to (11), the display device is a liquid crystal display device.

Here, the above-enumerated constitutions are merely examples and the present invention is not limited to these constitutions and various modifications can be made without departing from the technical concept of the present invention.

To briefly explain advantageous effects obtained by the typical inventions among the inventions disclosed in this specification, they are as follows.

According to the display device of the present invention, when the frame inversion driving method is adopted as the common inversion driving method, it is possible to shorten time until an operation becomes stable.

### BRIEF DESCRIPTION OF THE DRAWINGS

FIG. 1 is a block diagram showing the schematic constitution of a liquid crystal display module adopted by the present invention;

FIG. 2 is a circuit diagram showing the circuit constitution of a common voltage generating circuit of an embodiment 1 of the present invention.

FIG. 3A to FIG. 3D are views for explaining an operation of the common voltage generating circuit of an embodiment 1 of the present invention;

FIG. 4 is a view showing one example of a method of generating a first voltage (Vcom Swing) shown in FIG. 3A;

FIG. 5 is a circuit diagram showing the circuit constitution of the common voltage generating circuit of the embodiment 1 of the present invention;

FIG. 6A to FIG. 6D are views for explaining an operation of one example of a conventional common voltage generating circuit used in a common inversion driving method; and

FIG. 7A to FIG. 7D are views for explaining an operation of one example of a conventional common voltage generating circuit used in a common inversion driving method.

### DESCRIPTION OF THE PREFERRED EMBODIMENTS

Hereinafter, embodiments in which the present invention is applied to a liquid crystal display device are explained in detail in conjunction with drawings.

Here, in all drawings for explaining the embodiments, parts having identical functions are given same symbols and their repeated explanation is omitted.

[Liquid Crystal Display Module Adopted by the Present Invention]

FIG. 1 is a block diagram showing the schematic constitution of a liquid crystal display module adopted by the present invention.

On a liquid crystal panel (PNL), a plurality of scanning lines (or gate lines) (G1 to G320) and a plurality of video lines (also referred to as source lines or drain lines) (S1 to S720) which are respectively arranged in parallel.

Pixel portions are formed corresponding to portions where the scanning lines (G) and the video lines (S) intersect each other. The plurality of pixel portions are arranged in a matrix array, wherein each pixel portion includes a pixel electrode (ITO1) and a thin film transistor (TFT). In FIG. 1, the number of sub pixels in the liquid crystal panel (PNL) is 240×320×3.

A counter electrode (a common electrode) (IT02) is arranged to face each pixel electrode (ITO1) in an opposed manner while sandwiching liquid crystal therebetween. Accordingly, a liquid crystal capacitance (LC) is generated between each pixel electrode (ITO1) and the counter electrode (ITO2).

The liquid crystal panel (PNL) is configured as follows. A glass substrate (a first substrate) (GLASS) on which the pixel electrodes (ITO1), the thin film transistors (TFT) and the like are formed, and a glass substrate (a second substrate) (not shown in the drawing) on which color filters and the like are formed are overlapped to each other with a predetermined gap therebetween. Both substrates are laminated to each other by a frame-like sealing material in the vicinity of a peripheral portion between both substrates. Further, the liquid crystal is filled and sealed in the inside of the sealing material between both substrates from a liquid crystal filling port formed in a portion of the sealing material. Further, polarizers are laminated to the outsides of both substrates.

Here, the present invention is not relevant to the inner structure of the liquid crystal panel and hence, the detailed explanation of the inner structure of the liquid crystal panel is omitted. Further, the present invention is applicable to the liquid crystal panel having any structure. For example, in a vertical electric field type liquid crystal panel, the counter electrodes are formed on the second substrate. In a lateral electric field type liquid crystal panel, the counter electrodes are formed on the first substrate. Further, the color filters may be formed on the first substrate.

In the liquid crystal display module shown in FIG. 1, a drive circuit (DRV) is mounted on the glass substrate (GLASS).

The drive circuit (DRV) includes a controller circuit 100, a source driver (drain driver) 130 which drives the video lines (S) on the liquid crystal panel (PNL), a gate driver 140 which drives the scanning lines (G) on the liquid crystal panel (PNL), and a liquid crystal drive power source generating circuit 120 which generates power source voltages necessary for displaying images on the liquid crystal panel (PNL) (for example, a common voltage (Vcom) which is supplied to the counter electrodes (ITO2) on the liquid crystal panel (PNL)), and a memory circuit (hereinafter referred to as a RAM) 150. Further, in FIG. 1, FPC indicates a flexible printed circuit board.

Here, in FIG. 1, a case in which the drive circuit (DRV) is constituted by one semi-conductor chip is illustrated. However, the drive circuit (DRV) may be directly formed on the glass substrate (GLASS) using a thin film transistor which adopts low-temperature poly-silicon on a semiconductor layer, for example.

In the same manner, a circuit which constitutes a part of the drive circuit (DRV) may be divided thus constituting the drive circuit (DRV) using a plurality of semiconductor chips. Further, a circuit which constitutes a part of the drive circuit (DRV) may be directly formed on the glass substrate (GLASS) using a thin film transistor which adopts low-temperature poly-silicon on a semiconductor layer, for example.

Further, in place of mounting the drive circuit (DRV) or the circuit which constitutes a part of the drive circuit (DRV) on the glass substrate (GLASS), these circuits may be formed on a flexible printed circuit board.

To the controller circuit 100, display data and display control signals are inputted from a microcontroller unit (hereinafter referred to as MCU) of a main computer side, a graphic controller or the like.

In FIG. 1, symbol SI indicates a system interface, wherein the system interface constitutes a system to which various control signals and image data are inputted from the MCU and the like.

Symbol DI indicates a display data interface (a RGB interface), wherein the display data interface DI constitutes a system (external data) in which image data formed by an external graphic controller and clocks for fetching data are continuously inputted.

In this display data interface (DI), the image data are sequentially fetched in conformity with the data fetching clock in the same manner as a drain driver which is used in a conventional personal computer.

The controller circuit 100 transmits the image data received from the system interface (SI) and the display data interface (DI) to the source driver 130 and the RAM 150 and controls a display.

### Embodiment 1

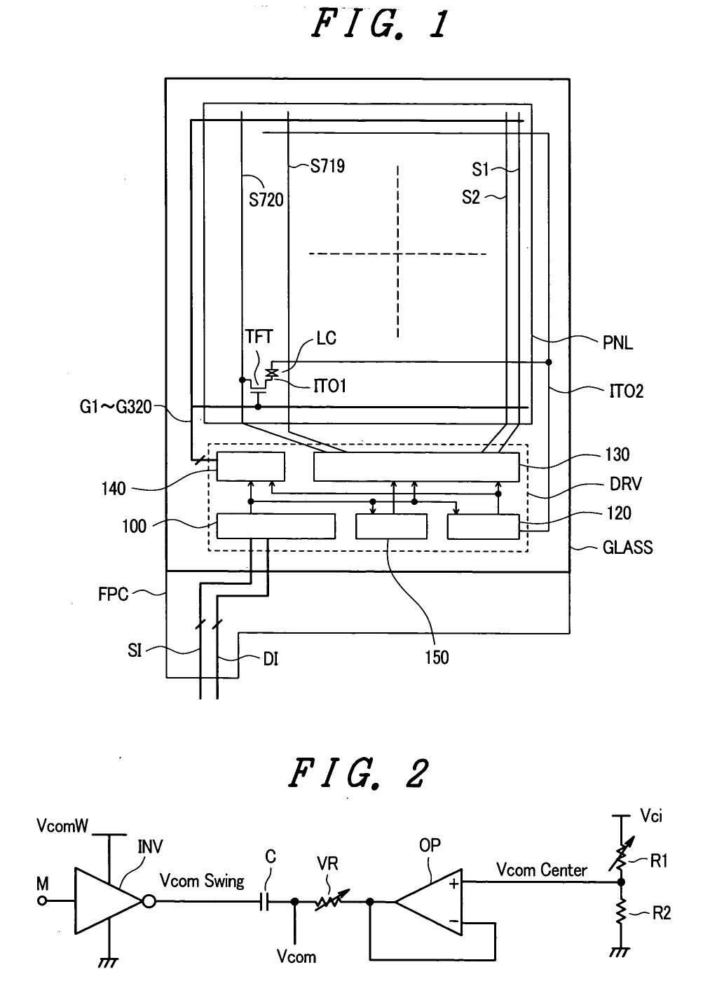

FIG. 2 is a circuit diagram showing the circuit constitution of a common voltage generating circuit of the embodiment 1 of the present invention. The common voltage generating circuit of this embodiment is provided in the inside of the liquid crystal drive power source generating circuit 120 shown in FIG. 1.

The common voltage generating circuit of this embodiment includes a coupling capacitor (C) and a valuable resistance element (VR), wherein a first voltage (Vcom Swing) is applied to one terminal of the coupling capacitor (C), and a common voltage (Vcom) having amplitude of VcomW which is applied to the counter electrode is outputted from a node between another terminal of the coupling capacitor (C) and the valuable resistance element (VR).

Further, to another terminal of the valuable resistance element (VR), a second voltage (Vcom Center) is applied. Here, the second voltage (Vcom Center) is applied to another terminal of the valuable resistance element (VR) through a voltage follower circuit which uses an operational amplifier (OP).

The second voltage (Vcom Center) is a center voltage of the common voltage (Vcom), wherein the second voltage (Vcom Center) is generated by dividing a reference voltage (Vci) using a divider circuit which is constituted of a valuable resistance element (R1) and a resistance element (R2). Here, the valuable resistance element (R1) serves to adjust the second voltage (Vcom Center) which is the center voltage of the common voltage (Vcom).

While the first voltage (Vcom Swing) is applied to one terminal of the coupling capacitor (C), this first voltage (Vcom Swing) is outputted from an inverter (INV).

A power source voltage having a magnitude of VcomW is supplied to the inverter (INV), while a polarity inverting signal (an alternating signal) (M) which is supplied from the controller circuit 100 is inputted to an input terminal of the inverter (INV). Accordingly, an inversion output of the polarity inverting signal (M) is outputted from the inverter (INV) as the first voltage (Vcom Swing) at a cycle of the polarity inverting signal (M) and with an amplitude of VcomW.

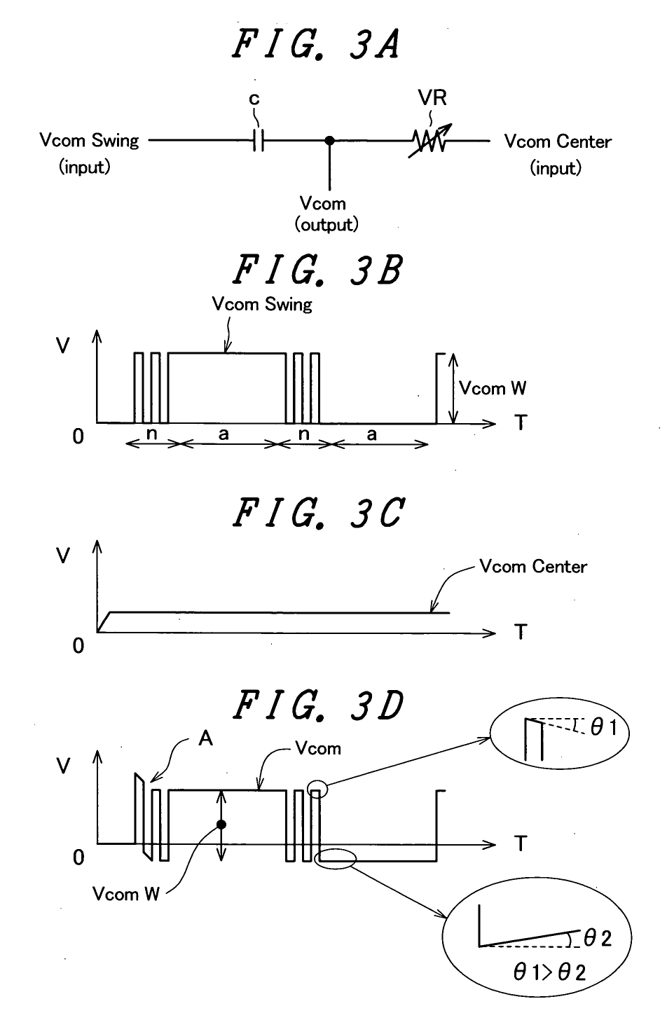

FIG. 3A shows a basic circuit of the common voltage generating circuit of this embodiment, FIG. 3B shows a voltage waveform of the first voltage (Vcom Swing) in the common voltage generating circuit of this embodiment, FIG. 3C shows a voltage waveform of the second voltage (Vcom Center) in the common voltage generating circuit of this embodiment, FIG. 3D shows the common voltage (Vcom) in the common voltage generating circuit of this embodiment. In FIG. 3B to FIG. 3D, symbol V indicates a voltage and symbol T indicates time.

A common inversion driving method of this embodiment is basically a frame inversion drive method. In this embodiment, during a first period (n) (a non-display period and a vertical blanking period) of a 1 frame period, a resistance value of the valuable resistance element (VR) is set to Rs (a small value) and, further, different from a usual frame inversion driving method, the first voltage (Vcom Swing) is made to swing at a predetermined cycle (for example, for every 1 horizontal scanning period).

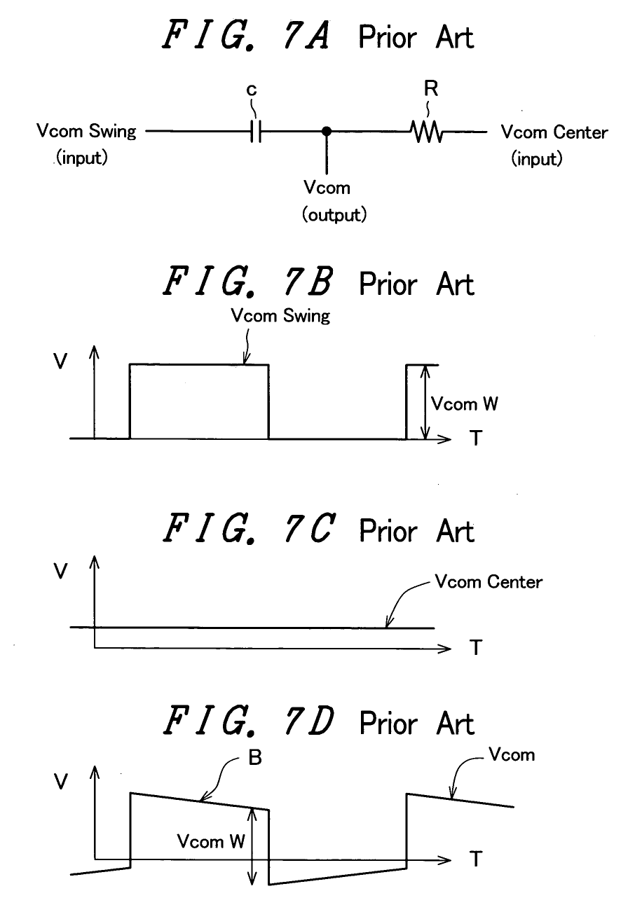

That is, during the first period (n), a voltage level of the first voltage (Vcom Swing) is changed from one voltage level to another voltage level out of a first voltage level (a potential of VcomW) and a second voltage level (GND) and, thereafter, the voltage level is changed one time or more from another voltage level to one voltage level. In other words, during the first period (n), the sum of the number of times that the voltage level of the first voltage is changed from the first voltage level to the second voltage level and the number of times that the voltage level of the first voltage is changed from the second voltage level to the first voltage level is two times or more. It is preferable that this total number is three times or more. The example shown in FIG. 3B shows a case in which the total number is five times. Here, in the usual frame inversion, as shown in FIG. 7B, the total number is only one time and hence, this embodiment largely differs from the prior art.

Accordingly, in this embodiment, as indicated by A in FIG. 3D, it is possible to readily converge the average voltage of the common voltage (Vcom) to the second voltage (Vcom Center) In a second period (a) (display period) which continuously follows the first period (n) in the 1 frame period, the resistance value of the valuable resistance element (VR) is set to Rb (a large value, Rb>Rs) and, further, in the second period (a), the first voltage (Vcom Swing) is not made to swing in the same manner as the usual frame inversion driving method.

That is, in the second period (a), the changeover of the voltage level of the first voltage (Vcom Swing) is not performed and the first voltage (Vcom Swing) is held at the first voltage level (the potential of VcomW) or the second voltage level (GND)

Accordingly, in this embodiment, it is possible to suppress the attenuation of the common voltage (Vcom) thus preventing the generation of flickers on the liquid crystal display panel.

Here, the second period (a) is set longer than the first period (n).

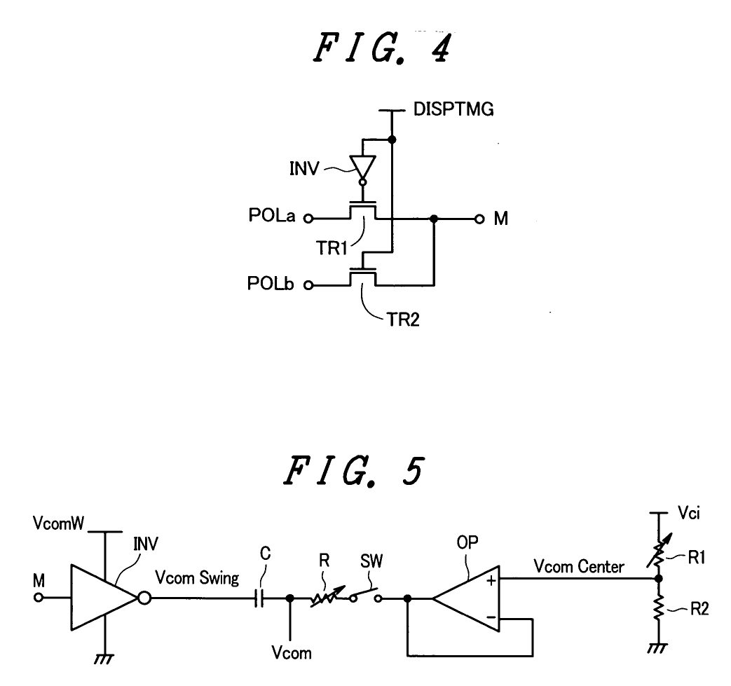

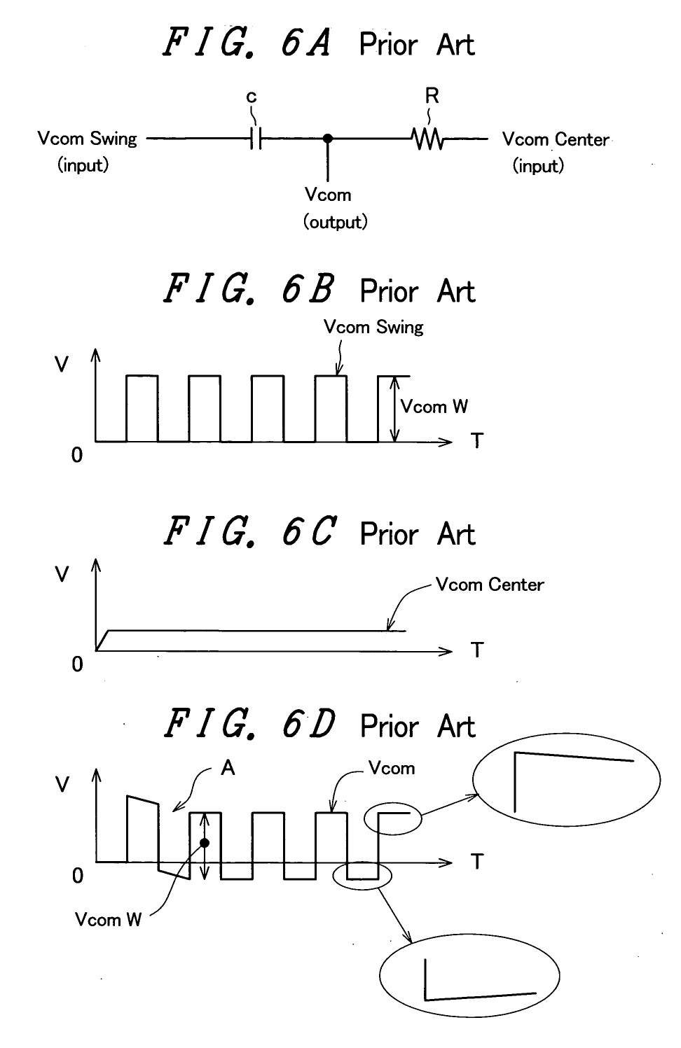

The first voltage (Vcom Swing) in this embodiment can be generated by the method shown in FIG. 4, for example.

In FIG. 4, symbol POLa indicates a polarity inversion signal 1 having a voltage waveform of the first voltage (Vcom Swing) in the first period (n) in FIG. 3B, symbol POLb indicates a polarity inversion signal 2 having a voltage waveform of the first voltage (Vcom Swing) in the second period (a) in FIG. 3B, and symbol DISPTMG indicates a signal which expresses a range in which display data is effective (display period).

Further, an inversion signal of the DISPTMG signal is inputted to a gate of an n-type MOS transistor (TR1), while the DISPTMG signal is inputted to a gate of the n-type MOS transistor (TR2).

In a circuit shown in FIG. 4, during the first period (n) in FIG. 3B, the n-type MOS transistor (TR1) is turned on and the n-type MOS transistor (TR2) is turned off, and in the second period (a) in FIG. 3B, the n-type MOS transistor (TR1) is turned off and the n-type MOS transistor (TR2) is turned on thus generating the first voltage (Vcom Swing) shown in FIG. 3B.

### Embodiment 2

FIG. 5 is a circuit diagram showing the circuit constitution of a common voltage generating circuit of an embodiment 2 of the present invention.

A common voltage generating circuit of this embodiment differs from the above-mentioned common voltage generating circuit of the embodiment 1 with respect to a point that a resistance element (R) is used in place of the valuable resistance element (VR) and a point that a second voltage (Vcom Center) is applied to another terminal of the resistance element (R) via a switching element (SW).

Here, voltage waveforms in this embodiment are equal to the voltage waveforms shown in FIG. 3B, FIG. 3C and FIG. 3D in the above-mentioned embodiment 1.

In this embodiment, the switching element (SW) is turned on in a first period (n) (a non-display period and also a vertical blanking period) of a 1 frame period. This corresponds to a case in which the resistance value of the valuable resistance element (VR) is set to Rs (the small value) in the above-mentioned embodiment 1. Further, in the same manner as the embodiment 1, different from the usual frame inversion driving method, a first voltage (Vcom Swing) is made to swing at a predetermined cycle (for example, for every 1 horizontal scanning period).

That is, during the first period (n), a voltage level of the first voltage (Vcom Swing) is changed from one voltage level to another voltage level out of a first voltage level (a potential of VcomW) and a second voltage level (GND) and, thereafter, the voltage level is changed one time or more from another voltage level to one voltage level.

Due to such constitution, also in this embodiment, it is possible to readily converge an average voltage of the common voltage (Vcom) to the second voltage (Vcom Center).

Next, in a second period (a) (display period) which continuously follows the first period (n) of the 1 frame period, the switching element (SW) is turned off. This corresponds to a case in which the resistance value of the valuable resistance element (VR) (the large value Rb>Rs; here, Rb≈infinity) in the above-mentioned embodiment 1.

Further, in the second period (a), the first voltage (Vcom Swing) is not made to swing in the same manner as the usual frame inversion driving method.

Accordingly, also in this embodiment, it is possible to suppress the attenuation of the common voltage (Vcom) and hence, it is possible to prevent the generation of flickers on the liquid crystal display panel. Further, this embodiment has an advantage that the constitution becomes more simplified compared to the above-mentioned embodiment 1.

### Embodiment 3

This embodiment is an embodiment which focuses on a waveform form chart shown in an enlarged view (a portion surrounded by circle in the drawing) in FIG. 3D.

In this embodiment, at the time of generating the common voltage (Vcom), the voltage level of the common voltage (Vcom) is changed over at a first cycle during the first period (m) (the non-display period), and the voltage level of the common voltage (Vcom) is changed over at a second cycle which is longer than the first cycle during the second period (a) (display period).

Accordingly, also in this embodiment, it is possible to readily converge the average voltage of the common voltage (Vcom) to the second voltage (Vcom Center).

Here, it is preferable that the first cycle is the 1 horizontal scanning period cycle. However, the first cycle is not limited to such a cycle and may be a 2 horizontal scanning period cycle or other cycles.

Further, it is desirable not to perform the changeover of the voltage level of the common voltage during the display period within the 1 frame period. For example, it is desirable that the second cycle is a cycle of the display period. Due to such a constitution, it is possible to perform the frame inversion driving. However, the present invention is not limited to such changeover of the voltage level of the common voltage and the present invention is also applicable to the changeover of the voltage level of the common voltage in the course of the display period. Also in such a case, the second cycle is set longer than the first cycle.

In this embodiment, the voltage level of the common voltage (Vcom) is attenuated with the first inclination θ1 during the non-display period, and the voltage level of the common voltage (Vcom) is attenuated with the second inclination θ2 which is smaller than the first inclination θ1 during the display period and hence, it is possible to obtain a further enhanced attenuation effect. Accordingly, in addition to the advantage that the average voltage of the common voltage (Vcom) can be readily converged to the second voltage (Vcom Center), it is also possible to attenuate the voltage level of the common voltage (Vcom) during the display period. Here, a control of the inclination of the attenuation of the voltage waveform can be realized by controlling a time constant of the attenuation using the methods explained in conjunction with the embodiment 1 or embodiment 2, for example.

Although the inventions made by inventors of the present invention have been specifically explained in conjunction with the above-mentioned embodiments, the present invention is not limited to the above-mentioned embodiments, and it is needless to say that various modifications can be made without departing form the gist of the present invention.

Further, the present invention is not limited to the liquid crystal display device, and is applicable to a display device which changes over a voltage level periodically.

What is claimed is:

1. A display device comprising a plurality of pixels each of which includes a pixel electrode and a counter electrode which faces the pixel electrode in an opposed manner, and a drive circuit which drives the plurality of pixels, wherein
the drive circuit includes a common voltage generating circuit which supplies a common voltage to the counter electrodes, and
the common voltage generating circuit changes over a voltage level of the common voltage with a first cycle in a non-display period, and changes over the voltage level of the common voltage with a second cycle which is longer than the first cycle in a display period.

2. A display device according to claim 1, wherein the common voltage generating circuit attenuates the voltage level of the common voltage with a first inclination during the non-display period and attenuates the voltage level of the common voltage with a second inclination which is smaller than the first inclination during the display period.

3. A display device according to claim 1, wherein the first cycle is a 1 horizontal scanning period cycle.

4. A display device according to claim 1, wherein the common voltage generating circuit does not perform the changeover of the voltage level of the common voltage during the display period in a 1 frame period.

5. A display device according to claim 1, the display device is a liquid crystal display device.

6. A display device comprising a plurality of pixels each of which includes a pixel electrode and a counter electrode which faces the pixel electrode in an opposed manner, and a drive circuit which drives the plurality of pixels, wherein
the drive circuit includes a common voltage generating circuit which supplies a common voltage to the counter electrodes,
the common voltage generating circuit includes a capacitive element having one terminal to which a first voltage is applied and another terminal which constitutes an output of the common voltage, and
a resistance element having one terminal which is connected to the another terminal of the capacitive element and another terminal to which a second voltage is applied,
the first voltage is a voltage whose voltage level is alternately changed from a first voltage level to a second voltage level having a potential lower than a potential of the first voltage level or from the second voltage level to the first voltage level,
a 1 frame period includes a first period and a second period which continuously follows the first period and is longer than the first period,
in the first period, a sum of the number of change of the first voltage from the first voltage level to the second voltage level and the number of change of the first voltage from the second voltage level to the first voltage level is twice or more, and
in the second period, the first voltage has the voltage level thereof held at either one of the first voltage level and the second voltage level.

7. A display device according to claim 6, wherein a resistance value of the resistance element in the second period in the 1 frame period is higher than a resistance value of the resistance element in the first period in the 1 frame period.

8. A display device according to claim 6, wherein the display device includes a switching element which is connected to the another terminal of the resistance element,
the resistance element is configured such that the second voltage is applied to the another terminal of the resistance element via the switching element, and
the switching element is turned on in the first period of the 1 frame period, and is turned off in the second period of the 1 frame period.

9. A display device according to claim 6, wherein the first period of the 1 frame period is a vertical blanking period.

10. A display device according to claim 6, wherein the first period of the 1 frame period is a non-display period, and the second period of the 1 frame period is a display period.

11. A display device according to claim 6, wherein in the first period of the 1 frame period, the first voltage has, in a 1 horizontal scanning period cycle, the voltage level thereof changed from the first voltage level to the second voltage level or from the second voltage level to the first voltage level.

12. A display device according to claim 6, wherein the display device is a liquid crystal display device.
